(19) United States
(12) Patent Application Publication
(10) Pub. No.: US 2026/0291531 A1
(43) Pub. Date: Sep. 24, 2026

(54) DYNAMIC RADIO FREQUENCY RANGING

(71) Applicant: Swift Beat, LLC, Menlo Park, CA (US)

(72) Inventor: Joseph A. KAISER, JR., Hopkinton, MA (US)

(21) Appl. No.: 19/467,791

(22) Filed: Feb. 2, 2026

Related U.S. Application Data
(60) Provisional application No. 63/753,348, filed on Feb. 3, 2025.

(51) Int. Cl. H04B 1/04; H04W 52/28; H04W 52/52

(52) U.S. Cl. CPC H04B 1/0475; H04W 52/283; H04W 52/52; H04B 2001/0416

(57) ABSTRACT

A dynamic gain ranging device and associated systems and methods are disclosed for adaptively processing radio frequency signals over a wide dynamic range of signal conditions. The device includes an RF receiving architecture that selectively applies attenuation and amplification based on measured signal characteristics, such as received signal strength, channel power, or signal-to-noise ratio, to maintain signal integrity and protect downstream components. By dynamically adjusting gain states in response to varying signal strengths and inferred proximity to a signal emitter, the device prevents saturation from strong signals while preserving sensitivity to weak signals. The disclosed techniques are applicable to airborne, uncrewed, and other platforms for detecting, tracking, and navigating relative to signal emitters, including operational signals and interference sources, and enable robust RF signal processing across large distances and interference-prone environments.

### CROSS-REFERENCE TO RELATED APPLICATION

This application claims the benefit of U.S. Provisional Application No. 63/753,348 filed Feb. 3, 2025, the entirety of which is hereby incorporated by reference herein.

### BACKGROUND

In radio frequency (RF) receiving systems, signal detection and processing are often constrained by fixed or limited gain architectures that are unable to adequately respond to wide and rapid variations in received signal strength. Conventional receivers typically rely on static gain stages or coarse automatic gain control techniques that are optimized for nominal operating conditions, but such approaches frequently struggle to maintain performance when exposed to large dynamic ranges, long-distance propagation losses, or strong nearby interferers. In electronically congested environments, including those affected by intentional or unintentional interference, strong RF signals can saturate front-end components or analog-to-digital converters (ADCs), while weak signals may be driven below the noise floor, resulting in reduced sensitivity and degraded signal-to-noise ratio (SNR). Existing interference mitigation techniques often assume relatively stable interference profiles and lack the ability to dynamically adapt system parameters in real time. As a result, traditional RF receiving systems face inherent tradeoffs between sensitivity, robustness, and component protection, limiting their effectiveness across diverse operational scenarios such as long-range detection, precision navigation, and interference-heavy environments.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for signal processing and dynamic gain ranging include: converting, by an antenna device, a radio frequency signal to an alternating current (AC) signal; attenuating the AC signal by a predetermined attenuation amount when a signal strength of the AC signal exceeds a first predetermined threshold, thereby generating a first interim signal; amplifying the first interim signal by a gain value when the signal strength of the first interim signal is below a second predetermined threshold, thereby generating a second interim signal; attenuating the second interim signal by a first attenuation value when the signal strength of the second interim signal is above a third predetermined threshold and a second attenuation value when the signal strength of the second interim signal is below the third predetermined threshold, thereby generating an output signal; and transmitting the output signal to at least one downstream electronic component.

Example dynamic gain ranging devices include: an antenna configured to receive a radio frequency signal as an analog input signal; a circuit protection component including a first attenuator, the circuit protection component being configured to pass the analog input signal through the first attenuator when a signal strength of the analog input signal exceeds a first predetermined threshold, thereby generating a first interim signal; an amplification component configured to amplify the first interim signal by a gain value when the signal strength of the first interim signal is below a second predetermined threshold, thereby generating a second interim signal; and an attenuator component configured to: attenuate the second interim signal by a first attenuation value when the signal strength of the second interim signal is above a third predetermined threshold and a second attenuation value when the signal strength of the second interim signal is below the third predetermined threshold, thereby generating an output signal; and transmit the output signal to at least one downstream electronic component.

### BRIEF DESCRIPTION OF THE DRAWINGS

The disclosed examples are described in detail below with reference to the accompanying drawing figures listed below:

FIG. 1 is a diagram illustrating an aircraft that implements a dynamic gain ranging device for modifying signals received from a signal emitter;

FIG. 2 is an architecture diagram of the DGR device shown in FIG. 1;

FIG. 3A illustrates an example gain ranging scheme for use by the DGR device operating in a three-range configuration;

FIG. 3B is an example graph illustrating the channel power of the input signal at the DGR device against an approximate range in the three-range configuration of FIG. 3A;

FIG. 4A illustrates an example gain ranging scheme for use by the DGR device operating in a two-range configuration, such as when the signal emitter exhibits a low source error vector magnitude (EVM);

FIG. 4B is an example graph illustrating the channel power of the input signal at the DGR device against an approximate range in the two-range configuration of FIG. 4A;

FIG. 5A and FIG. 5B illustrate example spectral representation graphs demonstrating how the DGR device uses dynamic gain ranging to selectively manage an effective noise floor to reduce the number of signals processed;

FIG. 6 is a flow chart illustrating example operations performed by a dynamic gain ranging device, such as the DGR device described herein; and

FIG. 7 is a functional block diagram of a computing apparatus according to an embodiment.

Corresponding reference characters indicate corresponding parts throughout the drawings. Any of the figures may be combined into a single example or embodiment.

### DETAILED DESCRIPTION

In the field of radio frequency (RF) receiving systems, various methods and technologies have been developed for signal processing. Existing RF receiving architectures typically employ fixed gain stages, which may not adequately adjust to rapid variations in signal strength. Traditional systems often face difficulties in balancing sensitivity with robustness to interference, particularly in environments where electronic interference is prevalent. Some conventional radio frequency technologies incorporate basic interference suppression techniques. However, these approaches often assume a static solution for interference mitigation, lacking the adaptability needed to dynamically modify system parameters in response to varying interference profiles. For example, existing RF radio receives whose primary purpose is to receive global navigation satellite system (GNSS) signals (e.g., global positioning system (GPS) signals), there is no need to modify the received signal levels since GNSS signals received on the surface of the earth do not vary substantially, and thus do not require any front-end RF gain ranging. Thus, existing systems have limitations in achieving an effective balance between signal sensitivity and resistance to interference.

Examples described herein provide systems and methods for dynamically controlling receiver gain over a wide range of signal conditions. In examples, a dynamic gain ranging (DGR) device is provided as an RF front-end that adaptively modifies signal attenuation and amplification in response to measured characteristics of received RF signals, such as received signal strength indicator (RSSI), signal-to-noise ratio (SNR), channel power, or related metrics. The DGR device addresses limitations of conventional fixed-gain or static automatic gain control architectures by enabling continuous and responsive adjustment of receiver sensitivity, thereby protecting downstream electronics from saturation while preserving sensitivity to weak signals. The DGR device is applicable across a broad set of platforms and operational environments, including airborne, ground-based, and maritime systems, and is particularly suited for scenarios involving large variations in signal strength, long-range detection, and RF interference.

During operation, the DGR device receives RF signals through one or more antennas and processes the signals using a combination of circuit protection, low-noise amplification, and variable attenuation. Upon acquisition of an input signal, the DGR device evaluates signal characteristics, including amplitude and quality metrics, to determine an appropriate gain state. Based on this evaluation, the DGR device dynamically applies attenuation when strong signals are detected to prevent saturation of receiver components and analog-to-digital converters, and applies amplification when weaker signals are detected to maintain adequate SNR. In examples, these dynamic gain adjustments are implemented in multiple phases or ranges, such as two-range or three-range configurations, and include transitions between gain, bypass, and attenuation modes as the signal strength changes. These transitions are governed by predetermined or dynamically adjusted thresholds and may be informed by additional signal characteristics, including the inherent quality of the signal source.

The example DGR devise and dynamic gain ranging techniques described herein further enable the DGR device to infer relative range or proximity to a signal emitter based on measured signal characteristics and to continuously adapt receiver behavior as that range changes. As the DGR device and platform approaches a signal source, increased attenuation may be applied to accommodate rising channel power, while reduced attenuation or amplification may be applied as the platform moves farther away and received signal strength diminishes. In some examples, the DGR device also selectively raises the effective noise floor to suppress unwanted or spurious signals, thereby reducing processing burden and improving tracking of a desired signal. Through these adaptive mechanisms, the example DGR devices and systems maintain received signals within an optimal operational range across distances spanning from meters to tens of kilometers, enabling robust signal detection, tracking, navigation, and interference resilience in dynamically changing RF environments.

These example DGR devices, systems and methods are thus capable of dynamically adjusting signal processing parameters across a broad range of conditions. Examples include a dynamic gain ranging (DGR) device to accommodate various signal conditions such as those presented by signal interference. The DGR device is a receiving system that includes an adaptive dynamic range control mechanism that optimizes signal processing capability, particularly being configured for detecting and navigating to a signal emitter. Example systems are equipped with the ability to dynamically adjust RF gain based on detected signal strength and/or other signal characteristics. The dynamic adjustment prevents saturation from strong signals and maintains an adequate signal-to-noise ratio (SNR) for weaker signals, while protecting the components of the RF receiving system. The DGR device allows for precise detection and signal processing effectiveness over a large dynamic range of signals between distant RF sources and their levels encountered when approaching very closely. Further, in some examples, the DGR device is also configured to intentionally degrade the signal-to-noise ratio (SNR) level of the received signals, thereby allowing the DGR device to hide certain signals in a noise floor (e.g., for signals from other emitters that are not desired to track, or which may degrade the identification and detection process).

Example implementations include search and rescue operations in which signal emitters transmit relatively weak signals that may be difficult to detect. Example signal emitters include emergency position-indicating radio beacons (EPIRBs), personal locator beacons (PLBs), and/or other emergency locator transmitters. Further, other RF signal sources such as signal jammers may cause interference by transmitting interference signals on known RF bands, thereby hampering attempts to locate the weaker signals. In some examples, the DGR device is incorporated into a mobile platform or an uncrewed aerial vehicle (UAV) that is designed to not only receive and utilize GNSS signals (e.g., for use in navigation) or other such weak-signal emitters (e.g., EPIRBs), but also to operate within an area of operation that includes signal jamming emitters, and to intentionally track and target such emitters. Such example use cases thus subject the DGR device to a large dynamic range of signals (e.g., between distant jammers and close jammers).

Other use cases include rural area surveillance, urban environment navigation, or disaster response operations where platforms operating in the area may receive operational signals from strategically placed emitters (e.g., for consistent pathing within the environment), but may also receive interference signals from other RF sources within the environment.

Example DGR device and systems are configured to prevent signal quality degradation due to distance over a large range (e.g., 5 meters to 40 kilometers). These DGR devices and systems are further configured to maintain the signal capture dynamic-range within the optimum range of the ADC without encountering either saturation or noise-floor limiting. Some examples are operable to modify the received signal levels for a class of RF radio receivers whose primary purpose is to receive and track GPS (GNSS) signals, to focus on both a primary RF source and multiple RF sources, and to track those RF sources over a wide range of distances from far away to very close.

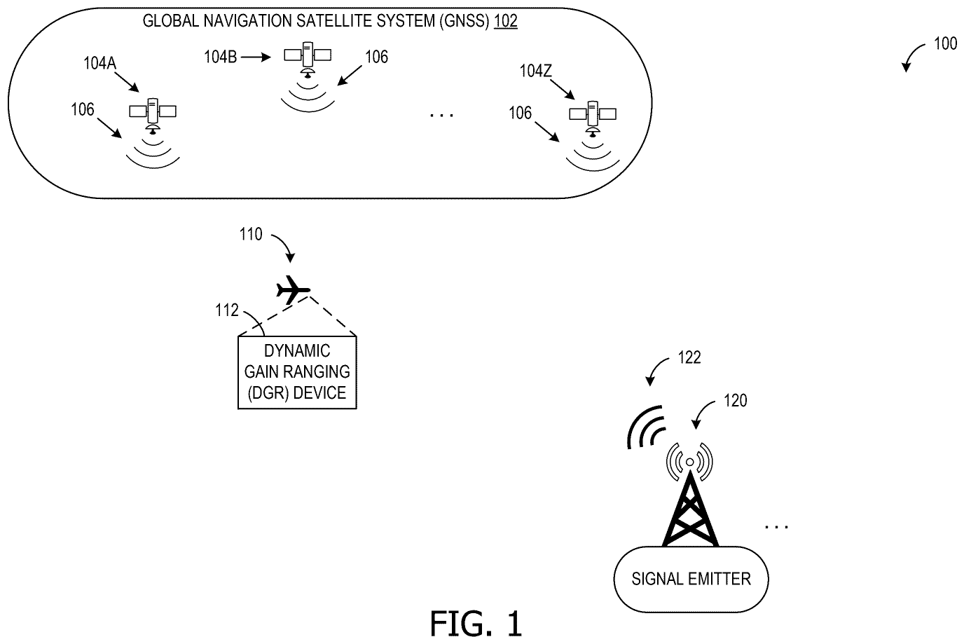

FIG. 1 is a diagram illustrating an aircraft 110 that implements a dynamic gain ranging device 112 for modifying signals received from a signal emitter (or just “emitter”) 120. While described with reference to aircraft 110, aspects of the disclosure are operable in any environment with fluctuating signal characteristics that necessitate the ranging operations described herein. For example, aircraft 110 may be any moving or stationary platform receiving RF signals from one or more emitters 120. Further, emitter 120 may be a moving or stationary platform.

In examples, the aircraft 110 represents any airborne or aerial platform capable of receiving radio frequency (RF) signals and carrying the dynamic gain ranging (DGR) device 112, whether crewed or uncrewed, mobile or hovering. Examples of the aircraft 110 include mobile platforms such as fixed-wing airplanes, rotary-wing aircraft such as helicopters, uncrewed aerial vehicles (UAVs) (including multi-rotor, fixed-wing, or hybrid vertical takeoff and landing (VTOL) platforms), lighter-than-air vehicles such as balloons or airships, and optionally high-altitude platforms. In some examples, the aircraft 110 includes military, commercial, governmental, or civilian platforms configured for missions such as, for example, search and rescue, surveillance, navigation assistance, interference detection or mitigation, disaster response, environmental monitoring, or autonomous navigation, and includes onboard flight control systems, navigation systems, communication systems, and signal processing electronics that utilize the output of the DGR device 112.

In the example, as the aircraft 110 is traveling (e.g., during flight operation), the aircraft 110 receives signals from various sources. More specifically, as shown in FIG. 1, the aircraft 110 is exposed to signals 122 from one or more ground-based emitters 120. In some examples, some ground-based emitters 120 emit operational signals being sought by the aircraft 110 (e.g., signals intended to be received and used for their designed purpose, such as GNSS signals, distress beacons, or the like). In some examples, some ground-based emitters 120 emit interference signals (also referred to herein as “jamming signals,” e.g., signals that are intended to degrade, disrupt, overwhelm, or otherwise negatively affect reception of operational signals).

In some examples, the signal 122 emitted by the emitter 120 is an operational signal being sought, tracked, and/or navigated toward by the aircraft 110. In some examples, the emitter 120 is an emergency or distress emitter configured to transmit signals indicating a distress condition or request for assistance, such as, for example, distress signals at 406 MHz or 121.5 MHz, emergency position-indicating radio beacons (EPIRBs), personal locator beacons (PLBs), emergency locator transmitters (ELTs), avalanche beacons, AIS-based man overboard devices (AIS-MOB), ship security alert systems (SSAS), search and rescue transponders (SARTs), and personal satellite messaging or emergency devices. In some examples, the emitter 120 is a navigation or positioning emitter such as maritime navigation aids, including lighthouse or buoy beacons, surveying beacons, geolocation beacons, cooperative navigation beacons deployed for autonomous vehicles or robotic systems, or temporary navigation beacons used in construction sites or special events.

In some examples, the emitter 120 is a tracking or asset-monitoring emitter, such as, for example, global positioning system (GPS) trackers, wildlife tracking beacons, tracking collars for livestock or pets, asset-tracking tags used in logistics or infrastructure monitoring, or underground or mining personnel locator beacons. In some examples, the emitter 120 is an aviation or aerospace emitter such as, for example, aircraft transponders (including Mode A, C, or S transponders), Automatic Dependent Surveillance-Broadcast (ADS-B) transmitters, mobile platform or UAV beacons, weather balloon radiosondes, or airborne or space-based telemetry transmitters.

In some examples, the emitter 120 is a maritime communication or identification emitter such as, for example, Automatic Identification System (AIS) transmitters or VHF-based digital selective calling (DSC) radios, or a public safety, security, or tactical emitter, including public safety radios operating in emergency or tactical modes, security or perimeter monitoring beacons, or emitters used for training or operational simulations. In some examples, the emitter 120 is a scientific, environmental, or research emitter such as, for example, scientific research beacons, environmental monitoring sensor nodes, or seismic and geological survey transmitters, or an industrial or smart-infrastructure emitter, including industrial equipment identification beacons, smart infrastructure transmitters associated with bridges, tunnels, rail systems, or utilities, and remote sensor nodes for facility monitoring. In some examples, the emitter 120 is test, calibration, or emulated emitters such as, for example, test transmitters, calibration beacons, or signal sources configured to emulate operational or interference signals. These categories and example emitters are non-limiting, and the emitter 120 may be stationary or mobile, cooperative or non-cooperative, and may transmit operational signals, interference signals, or combinations thereof.

In some examples, the aircraft 110 is navigating towards the emitter 120 based on the strength or other characteristic of the signal 122, to render aid, and applies the dynamic ranging described herein to process the signal 122 (e.g., for use in navigating to the emitter 120).

In some examples, the aircraft 110 is operating within a geographical area in which one or more of the emitters 120 disrupt signals from a global navigation satellite system (GNSS) 102 (e.g., GPS, Galileo, Quasi-Zenith Satellite System (QZSS), or the like). The GNSS 102, in this example, provides multiple satellites 104A-104Z (e.g., a constellation of satellites, collectively, satellites 104) that are configured to transmit signals 106 containing precise time and location data. In examples, the signals 106 transmitted by the GNSS 102 are radio frequency signals broadcast by multiple satellites and contain precisely time-stamped navigation messages that include, for example, satellite identification, orbital parameters (ephemeris and almanac data), and timing information generated from highly accurate onboard atomic clocks. These signals 106 are received by GNSS receivers, such as the aircraft 110. By measuring the time of flight of signals 106 from multiple satellites to a receiver, the receiver computes its position, velocity, and time (PVT), enabling accurate navigation, synchronization, and geolocation services. These signals 106 are referred to herein as “operational signals” or “legitimate signals” to distinguish from the “interference”, “disruptive signals”, or “jamming signals” that may be transmitted by nearby emitters 120, in some examples.

In examples, the GNSS 102 utilizes particular bands in the radio frequency spectrum for their operational signals 106. In the example of GPS, the satellites 104 transmit the operational signals 106 in the L-band of the radio frequency spectrum, including L1 (1575.42 megahertz (MHz)), L2 (1227.60 MHz), L5 (1176.45 MHz), or the like. Similarly, Galileo operates in the E-band of the radio frequency spectrum, including E1 (1575.42 MHz, compatible with GPS L1), E5a (1176.45 MHz), E5b (1207.14 MHz), E6 (1278.75 MHz), or the like. These bands ensure that the particular GNSS 102 can serve diverse applications with varying levels of accuracy, reliability, and security.

Other GNSS systems likewise use other predefined bands. However, since these predefined bands for the various GNSS's are publicly known, this predictability allows jammers (e.g., emitter 120) to interfere with those operational signals 106. For example, jammers can perform targeted interference, transmitting radio noise or false signals at the same frequencies as the GNSS bands. Since these operational signals 106 from the GNSS 102 are quite weak (e.g., typically around −130 dBm to −160 dBm) when the reach the Earth-based receivers, a jammer can overpower these weak signals. Jammers can also perform broadband jamming by transmitting across a range of frequencies, thereby simultaneously interfering with multiple signals, degrading positioning accuracy, or completely denying service. Beyond noise jamming more sophisticated devices can send fake GNSS signals on the same bands (e.g., in an attempt to trick receivers into calculating false positions or times). As such, the predictability of GNSS frequency bands, combined with the weak nature of satellite signals, makes them vulnerable to jamming or spoofing, posing risks to navigation, timing systems, and critical infrastructure that rely on the GNSS 102. For this example, it is presumed that the emitter 120 is a ground-based jammer that is configured to broadcast the signal 122 as an interference signal.

In the example of FIG. 1, the signal 122 emitted by the emitter 120 is a jamming signal. Examples of the signal emitter 120 when operating as a signal jammer (also referred to herein as a “jammer” or “jammer emitter”) include intentional interference sources designed to disrupt, deny, or manipulate RF communications or navigation signals. For example, such emitters include: GNSS jammers that transmit noise or structured interference in GNSS frequency bands (e.g., GPS L1/L2/L5, Galileo E1/E5/E6) to deny positioning and timing services; broadband noise jammers that emit high-power RF energy across a wide range of frequencies to overwhelm multiple receivers simultaneously; and spot or narrowband jammers that target specific known frequencies or channels used by communication or navigation systems. Additional examples include sweep jammers that rapidly scan interference across frequency ranges, pulsed jammers that transmit intermittent high-power bursts, and spoofing transmitters that broadcast counterfeit GNSS-like signals intended to mislead receivers into computing false position or time solutions.

Further examples of jammer emitters include ground-based vehicle-mounted jammers, portable handheld jammers, fixed-site jamming installations, airborne jammers mounted on aircraft or UAVs, and ship-based or maritime jammers. Jammer emitters also include: cellular jammers targeting LTE, 5G, or legacy cellular bands; Wi-Fi and Bluetooth jammers operating in the ISM bands; satellite communication jammers targeting uplink or downlink frequencies; and test or training jammers used by military, security, or research organizations to simulate interference conditions. In the context of FIG. 1, any such jammer may act as the emitter 120 whose interference signal is detected, processed, tracked, or navigated toward by the DGR device 112.

Accordingly, the example DGR device 112 allows the aircraft 110 to receive and alter those signals 122 to, for example, protect electronic instrumentation on the aircraft 110 (e.g., from powerful signals) or for greater reception (e.g., by enhancing weaker signals), as described herein. More specifically, the example aircraft 110 is equipped with DGR device 112. The DGR device 112 is equipped with signal detection and signal processing components that allow the dynamic gain ranging of the incoming RF signal(s) based on the signal strength of those signals 106, 122 (e.g., based on a received signal strength indicator (RSSI) value). Since it is presumed, in the jammer examples, that the interference signal 122 overpowers the operational signals 106, these examples focus on the signal 122 as being the dominant signal received by the aircraft 110. More specifically, the DGR device 112 dynamically adjusts the RF gain based on detected signal strength and/or other characteristics, performing signal attenuation when the dominant signal (e.g., interference signal 122) is strong and performing signal amplification when the signal 122 is weak. Attenuation of the signal 122 helps protect electronics of the DGR device 112 and other downstream electronics that process that signal when the signal 122 is strong (e.g., when the aircraft 110 is nearer to the emitter 120). Further, in some examples, the aircraft 110 is a UAV that is configured to identify, track, and/or navigate towards the emitter 120. As such, amplification of the interference signal 122 is useful when the emitter 120 is more distant from the aircraft 110, or otherwise when the transmission power of the signal 122 is weaker.

During operation, in the example of FIG. 1, the DGR device 112 performs signal detection and acquisition of the signal 122. The DGR device 112 includes one or more antenna that allow the DGR device 112 to receive at least the signal 122 via an RF receiving system (or an “RF front end”). The RF front end (not separately shown in FIG. 1) includes a wide dynamic range control mechanism that detects the presence of the emitter 120. The strength of this analog signal is referred to herein as an RSSI value (e.g., in decibels relative to a milliwatt (dBm)). Once the signal 122 is acquired, the DGR device 112 evaluates the strength of the received signal. This evaluation involves measuring parameters such as amplitude and SNR to ascertain the quality and reliability of the signal. The DGR device 112 dynamically adjusts the RF gain levels in response to the assessed signal strength. This adjustment ensures that the signal remains within the optimal operational range of the RF front end, preventing saturation from strong signals and maintaining sensitivity for weaker signals, thereby preserving signal integrity.

In examples, the DGR device 110 performs multi-phase dynamic ranging on the received signal, automatically altering the sensitivity and attenuation levels to handle variations in signal strength more effectively. Multi-phase dynamic ranging includes preemptively reducing gain when the aircraft 110 is near high-power jamming sources, such as the emitter 120 (e.g., attenuating the signal when the RSSI value exceeds a predetermined threshold), and increasing sensitivity for faint signals when the aircraft 110 is farther away from the jamming source (e.g., amplifying the signal when the RSSI value is below a predetermined threshold). These steps are executed in a seamless manner to ensure the aircraft 110 effectively tracks and navigates towards the emitter 120, overcoming challenges posed by varying signal conditions and potential electronic jamming sources.

In examples, the range thresholds at which attenuation or amplification are applied is determined and dynamically adjusted during the multi-phase dynamic ranging process. These phases are configurable to address varying signal conditions, such as proximity to interference sources and changes in signal strength as the aircraft 110 approaches or moves away from the signal emitter. In examples, such dynamic amplification/attenuation involves transitions between attenuation levels at specific distance intervals, for example, close proximity for higher attenuation levels near strong interference sources (e.g., at higher RSSI values), and reduced attenuation, or even signal amplification, as distance increases to allow for greater sensitivity to weaker signals (e.g., at lower RSSI values). Exact distance values for these transitions are defined according to system calibration and operational requirements, ensuring that the RF receiving system effectively manages signal integrity and robustness against interference.

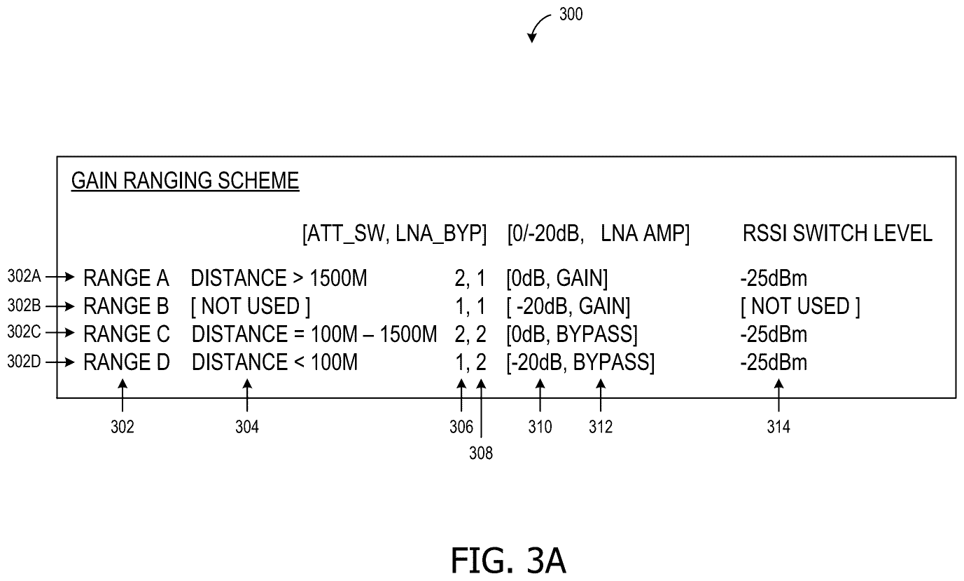

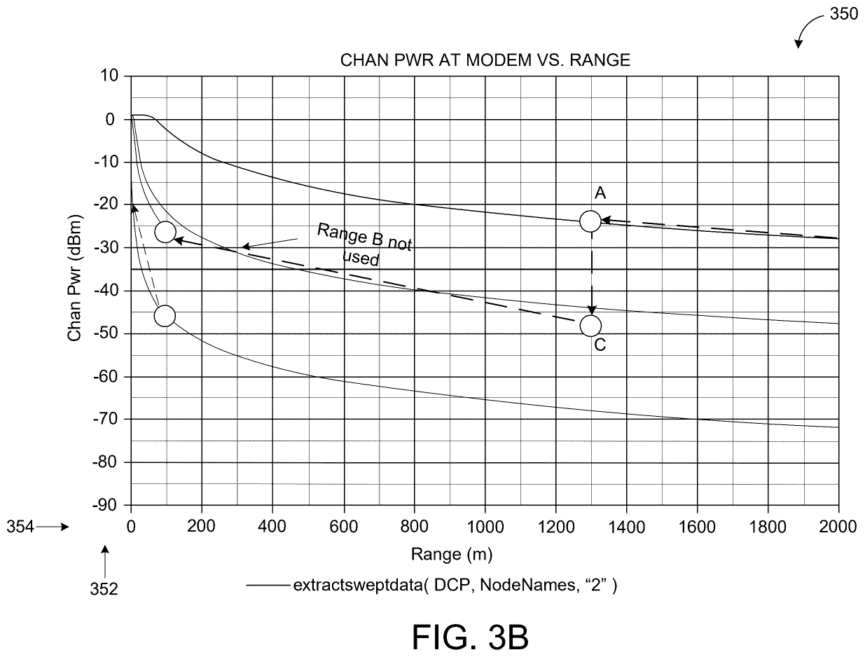

In some examples, the DGR device 112 is configured to automatically attenuate the incoming signal by 20 dB when the RSSI value is above −25 dBm (e.g., reducing the incoming signal strength by −20 dB), and the DGR device 112 is configured to automatically amplify the incoming signal by 20 dB when the signal strength is below −45 dBm, thus leaving an unmodified range between −25 dBm and −45 dBm. This embodiment is referred to herein as a three-range configuration. FIG. 3A and FIG. 3B provide additional examples and details regarding this three-range configuration.

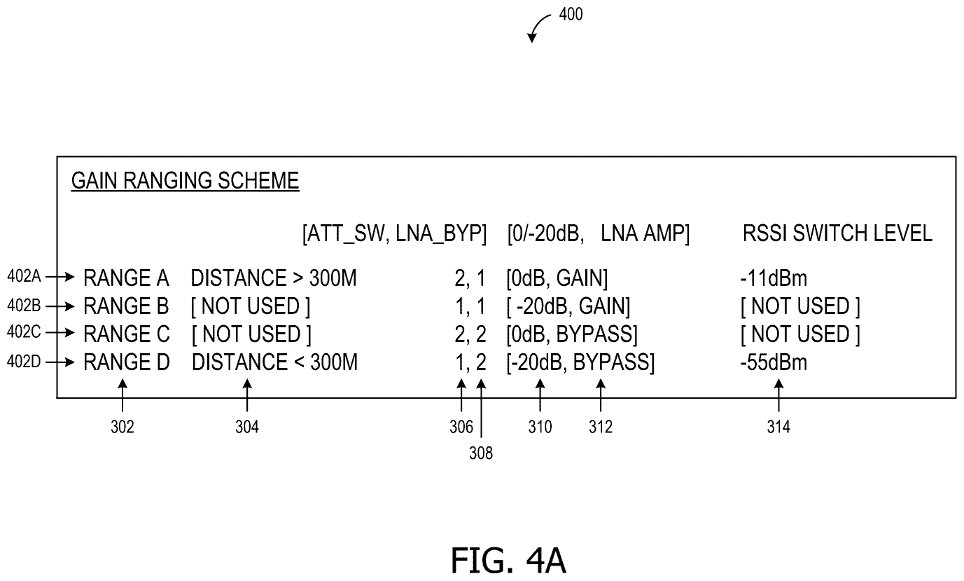

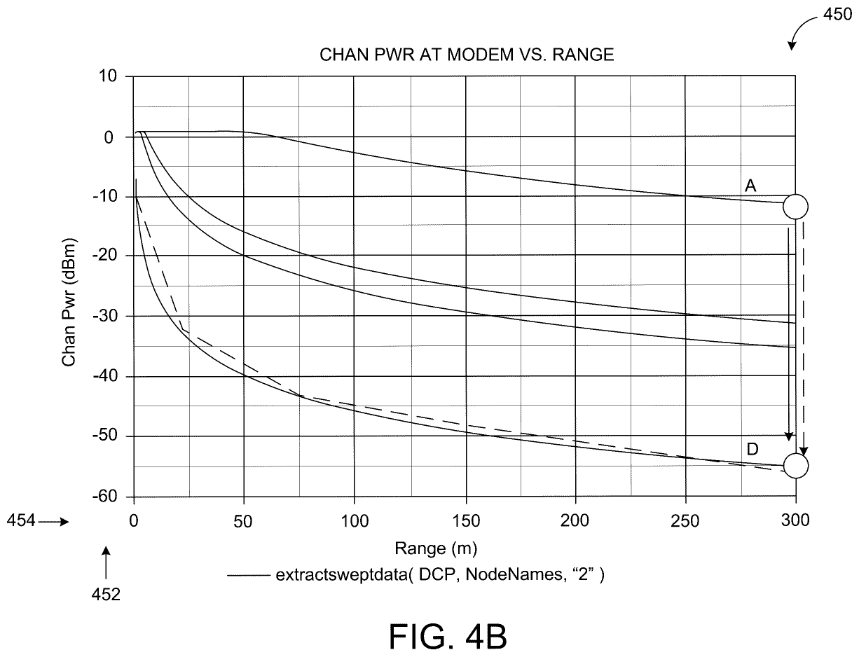

In some examples, the DGR device 112 is configured to automatically attenuate the incoming signal by 22 dB when the RSSI value is above a threshold value (e.g., −33 dBm), and the DGR device 112 is configured to automatically amplify the incoming signal by 22 dB when the RSSI value is below that threshold value (e.g., <−33 dBm), thus leaving no unmodified range. This embodiment is referred to herein as a two-range configuration. In some examples, the DGR device 112 is configured to dynamically shift between the three-range configuration and the two-range configuration when the signal (e.g., the emitter signal 122) has a low error-vector magnitude (EVM) characteristic. This is true if the signal under detection is intended primarily for jamming and has a low SNR ratio. In this case, it is less important to maintain high receiving system SNR (e.g., >20 dB) since the tracked signal itself has a low SNR (e.g., <20 dB). In such examples, only two gain ranges are used to successfully track this signal. As such, in this embodiment, the DGR device 112 considers both signal power (e.g., via RSSI value) as well as signal quality (e.g., expressed as the source's own SNR characteristic). FIG. 4A and FIG. 4B provide additional examples and details regarding this two-range configuration.

In some examples, the DGR device 112 is configured to attenuate the incoming signal by 20 dB when a distance to the emitter 120 is less than 100 meters, and the DGR device 112 is configured to amplify the incoming signal by 20 dB when the distance to the emitter 120 is greater than 1,600 meters. In examples, the determination of the distance from the emitter 120 is achieved through the assessment of the characteristics of the received signal, particularly focusing on its amplitude (e.g., the RSSI value of the signal) and the signal-to-noise ratio (SNR). By analyzing these parameters, the DGR device 112 ascertains the relative strength of the incoming signal, which is indicative of proximity to the emitter 120. In some examples, the attenuation and amplification thresholds of the DGR device 112 presume a predetermined signal strength of the emitter 120 and thus can approximate a distance to the emitter 120 based on the (unamplified/unattenuated) RSSI value, or based on the strength of a modified signal (e.g., knowing whether amplification or attenuation is currently being applied, as well as the settings for those signal modifications).

In some examples, upon acquiring the signal, the DGR device 112 measures the amplitude and SNR to evaluate the signal quality, which provides data regarding the distance of the aircraft 110 from the emitter. Based on this assessment, the DGR device 112 engages the dynamic gain ranging mechanism to adjust attenuation levels appropriately. The DGR device 112 systematically attenuates or boosts the signal depending on its strength, thereby dynamically modifying the degree of gain to ensure optimal signal processing. The attenuation levels are incrementally tuned as the aircraft 110 changes its distance relative to the emitter 120. For example, in conditions where the signal is strong due to closer proximity, higher attenuation may be applied to prevent saturation and maintain received signal integrity. Conversely, as the distance increases and signal strength diminishes, attenuation is reduced to augment sensitivity for weaker signals. This continuous adaptation allows the DGR device 112 to maintain effective performance amidst varying signal conditions and potential interference.

The relationship between channel power and range in the context of the DGR device 112 is fundamentally linked, in examples, to the characteristics of the received signal as the aircraft 110 approaches or recedes from the emitter 120. In examples, channel power, which is indicative of the strength of the signal received over a specific frequency band, serves as a proxy for the range or proximity of the aircraft 110 relative to the emitter 120. As the aircraft 110 comes closer to the emitter 120, the channel power typically increases due to the reduced transmission path and diminished free-space path loss, resulting in a stronger received signal 122. Conversely, as the aircraft 110 moves away from the emitter 120, the channel power decreases, attributed to increased path loss and potential environmental obstructions that attenuate the signal 122. This correlation between channel power and range allows the DGR device 112 to dynamically adjust its gain settings through the adaptive dynamic range control mechanism. By continuously monitoring the channel power, the DGR device 112 calibrates its sensitivity and attenuation levels to maintain signal integrity. Higher channel power, signifying close proximity, may prompt the DGR device 112 to increase attenuation to prevent signal saturation. On the other hand, lower channel power, indicating increased range, may necessitate a reduction in attenuation to enhance sensitivity to weaker signals. Overall, the relationship between channel power and range is leveraged by the DGR device 112 to dynamically adapt its operational parameters, ensuring robust performance across varying distances and signal conditions while mitigating interference and jamming.

While the example shown in FIG. 1 includes only one signal emitter 120, it should be understood that there could be multiple emitters 120. In such situations, the signals 122 from multiple emitters 120 may combine (e.g., as received by the DGR device 112) to provide a combined input signal to the DGR device 112, and that the DGR device 112 can likewise process that combined signal as described herein. Further, while the example described above presumes that the emitter 120 is a ground-based jammer, it should be understood that the emitter 120 could be an air-based (e.g., flying) jammer, a sea-based jammer, or any signal-emitting source (e.g., not a jammer). For example, the signal 122 being broadcast by the emitter 120 is an operational signal being sought by the aircraft 110, such as a distress signal, a homing signal, or the like. Alternatively, the signal 122 being broadcast by the emitter 120 is an interference signal being sought by the aircraft 110, such as a jamming signal.

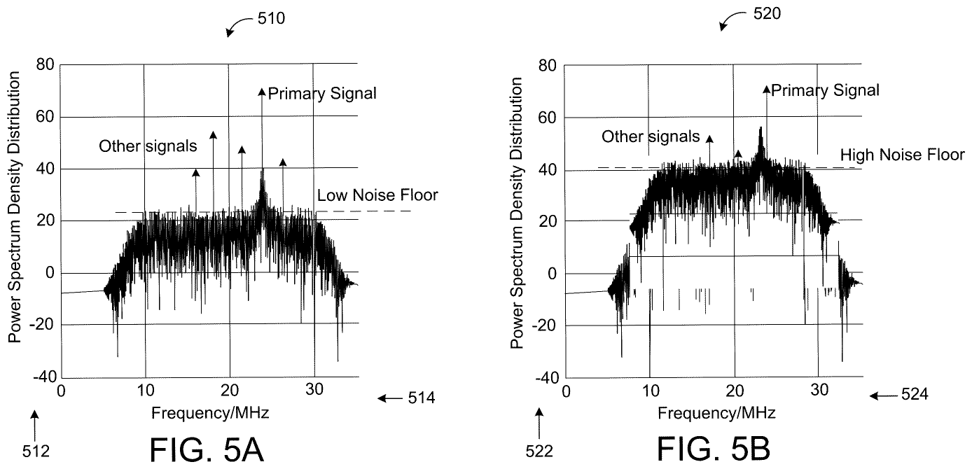

In some examples, the DGR device 112 uses the dynamic ranging scheme described above to reduce the number of emitter signals 122 to process by increasing the noise floor. In this embodiment, attenuation is added into the RF processing chain. By doing so, the DGR device 112 eliminates (e.g., hides) unwanted spurious signals, or even unwanted signals (e.g., when there are too many signals to efficiently process) in the noise floor such that they are not detectable by the DGR device 112. FIG. 5A and FIG. 5B provide additional examples and details regarding this particular embodiment.

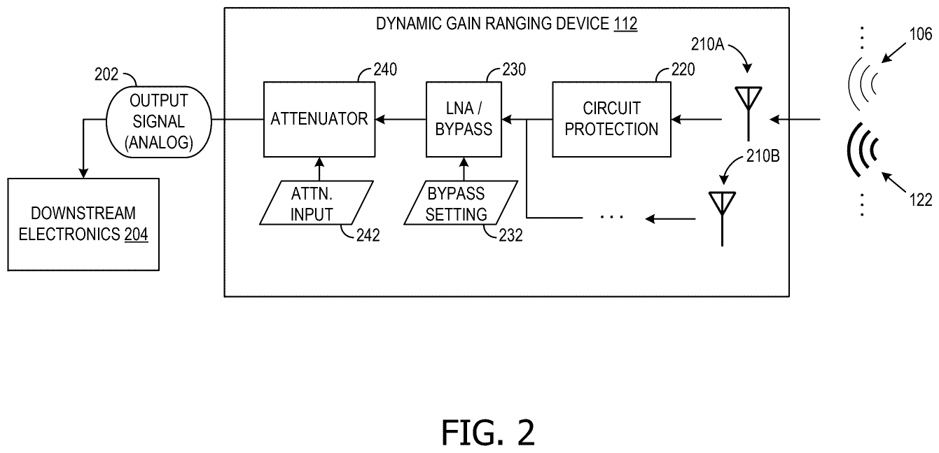

FIG. 2 is an architecture diagram of the DGR device 112 shown in FIG. 1. In the example, the DGR device 112 includes four primary components for receiving and signal processing of signals 106, 122 received by the aircraft 110, namely antennas 210A, 210B, circuit protection 220, LNA 230, and attenuator 240. During operation, the DGR device 112 receives signals 106, 122 (e.g., as a composite RF signal) via a primary antenna 210A, or alternately via a secondary antenna 210B. The DGR device 112 performs various signal processing operations on this “input signal” (not separately shown) before outputting this as an output signal 202 (e.g., as an analog signal) for use by other devices on the aircraft 110 (e.g., “downstream electronics” 204). As such, the DGR device 112 acts as an RF receiver or RF front end for the input signal, thereby generating the output signal 202 for use by other devices, dynamically performing signal attenuation (e.g., when signal strength is too high) and signal amplification (e.g., when the signal strength is too low).

In the example, the antennas 210 are patch antennas, a type of directional antenna that includes a flat, rectangular or circular metallic patch mounted on a dielectric substrate with a ground plane on the opposite side. In some examples, antennas 210 include any combination of microstrip patch antennas, printed monopole or dipole antennas or arrays, metamaterial antennas, phased-arrays (e.g., typically including patch arrays), or any other unit cell or multicell antennas, or the like. The antennas 210 are multi-band antennas configured to perform across various frequencies, including bands associated with GNSS 102 (e.g., GPS, Galileo, GLONASS, or the like), cellular communications, or the like. Only one of the antennas 210A, 210B are active at one time (the primary antenna 210A, in this example), and both antennas 210A, 210B are presumed to include the circuit protection 220 shown in FIG. 2.

In the example, the input signal is initially processed by circuit protection 220, a series of circuitry designed to attenuate over-powered signals when the input signal is too strong (e.g., exceeds a predefined threshold). In some examples, the circuit protection 202 includes a pair of switches (e.g., single pole double-throw (SPDT) RF switches, not separately shown) surrounding an attenuator (not separately shown). When the signal is routed through the attenuator of the circuit protection 220, the attenuator provides a fixed 20 dB attenuation to the signal. This signal first passes through an input switch that is configured to route the signal through the attenuator when the signal strength exceeds the predefined threshold. Otherwise, the signal is bypassed around the attenuator, leaving the signal largely unchanged. This circuit protection 220 helps reduce overpowered signals that may damage other electronic components, such as LNA 230, attenuator 240, or the other downstream electronics 204.

The LNA 230, in the example, is a low noise amplifier that is designed to amplify weak signals while minimizing the addition of noise to the signal. The LNA 230 operates from 700 MHz to 6 gigahertz (GHz) and provides a gain (G) of 21 dB with a noise figure (NF) of around 1 dB when in high-gain mode. The LNA 230 also includes a high-linearity bypass mode that allows the signal to pass through the LNA 230 without amplification when high gain is unnecessary (e.g., a gain of approximately 0 dB). The LNA 230 is configured for high-gain mode when the incoming signal strength is below a predetermined threshold (e.g., below −33 dBm) and bypass mode otherwise (here represented as bypass setting 232). In some examples of both the two-range and the three-range configurations, the LNA 230 is enabled when the RSSI value of the input signal is below a gain threshold (e.g., <−33 dBm, <−45 dBm, respectively), and bypassed otherwise. In examples, the LNA 230 is controlled and dynamically configured by the DGR device 112 via a control pin, where the DGR device 112 sends a digital signal to change the configuration of the LNA 230 based on the RSSI value, the SNR, or the like.

After the LNA 230, the signal passes through the attenuator 240. The attenuator 240, in the example, is a digital step attenuator configured to provide adjustable attenuation in discrete steps (e.g., 0.25 dB per step) over an attenuation range (e.g., 0 to 31.75 dB). In operation, the attenuation applied by the attenuator 240 is dynamically controlled based on an inferred distance between the aircraft 110 and the signal emitter 120, as determined from characteristics of the received signal such as received signal strength indicator (RSSI), channel power, or signal-to-noise ratio. In examples, the attenuator 240 is nominally set to approximately 10 dB of attenuation, applies little or no attenuation (e.g., 0 dB) when the received signal is weak and the inferred distance to the emitter is relatively large (e.g., greater than approximately 1,600 meters), and applies increased attenuation (e.g., 20 dB) when the received signal is strong and the inferred distance to the emitter is relatively small (e.g., less than approximately 100 meters). By dynamically varying attenuation in this manner, the attenuator 240 reduces the risk of saturation of downstream components while preserving sensitivity to weaker signals as the distance to the signal emitter changes.

In some examples, after processing by the DGR device 112, the output signal 202 is sent to an RF transceiver device (not separately shown) that is configured to convert the analog signal into digital baseband signals for further processing (e.g., analog-to-digital (ADC) conversion). Such digital signals may subsequently be used to track the emitter 120, determine a path to the emitter 120, determine a distance and/or direction to the emitter 120, or the like.

FIG. 3A illustrates an example gain ranging scheme 300 for use by the DGR device 112 operating in a three-range configuration. In this example, the gain ranging scheme 300 correlates an estimated distance between the aircraft 110 and the signal emitter 120 with specific control states of the attenuator 240 and the LNA 230, thereby defining discrete operating ranges for dynamic gain control. The scheme 300 includes multiple distance-based ranges 302, identified as Range A 302A, Range B 302B, Range C 302C, and Range D 302D. Each range 302 includes a range interval 304, a corresponding attenuator switch state (ATT_SW) 306, an LNA bypass state (LNA_BYP) 308, an attenuation value 310, and an LNA operating mode 312. Further, an RSSI switch level 314 (e.g., −25 dBm) is used by the DGR device 112 to determine transitions between amplification and bypass states of the LNA 230.

In the example, Range A 302A corresponds to a distance 304 of greater than 1500 meters. When the received signal is relatively weak, the DGR device 112 configures the attenuator 240 to apply no attenuation (e.g., 0 dB) while enabling the LNA 230 in a high-gain mode to amplify the signal. Range B 302B is shown as unused in this example and is reserved for optional intermediate configurations. Range C 302C corresponds to distances between approximately 100 meters and 1500 meters. When the received signal strength is sufficient without amplification, and the DGR device 112 configures the LNA 230 in a bypass mode while maintaining no attenuation through the attenuator 240. Range D 302D corresponds to distances less than 100 meters. When the received signal is relatively strong, the DGR device 112 applies increased attenuation (e.g., −20 dB) via the attenuator 240 while maintaining the LNA 230 in bypass mode. Collectively, the gain ranging scheme 300 enables the DGR device 112 to maintain the received signal within an optimal dynamic range across varying distances, preventing saturation at close proximity while preserving sensitivity at longer ranges.

FIG. 3B is an example graph 350 illustrating the channel power 352 of the input signal at the DGR device 112 against an approximate range 354 (in meters (m)) in the three-range configuration of FIG. 3A. In this example graph 350, the “A” point illustrates the threshold RSSI value at which the DGR device 112 transitions from amplification (e.g., “Gain”) to no amplification (e.g., “Bypass”). More specifically, as the DGR device 112 is at an approximate distance of 1300 meters or more from the signal emitter 120 (e.g., an unmodified RSSI value of <~−47 dBm), the DGR device 112 is amplifying the signal with +20 dB. When the DGR device 112 reaches the amplification threshold, the DGR device 112 changes the LNA 230 into “Bypass” mode, thus ceasing the amplification. This shift is illustrated between point “A” and point “C” in the graph. As the DGR device 112 continues to close range toward the signal emitter 120 (e.g., between a range of 1300 meters and approximately 100 meters), the input signal is neither being amplified nor attenuated. At a range of 100 meters (e.g., at an RSSI value of approximately −25 dBm), the DGR device 112 activates the attenuator 240 (e.g., at point “D”), thereby causing the input signal to be attenuated by −20 dB. This attenuated mode continues through range 100 meters to 0 meters.

FIG. 4A illustrates an example gain ranging scheme 400 for use by the DGR device 112 operating in a two-range configuration, such as when the signal emitter 120 exhibits a low source error vector magnitude (EVM). In this example, the gain ranging scheme 400 correlates an estimated distance between the aircraft 110 and the signal emitter 120 with specific control states of the attenuator 240 and the LNA 230, thereby defining a reduced set of operating ranges for dynamic gain control. The scheme 400 includes multiple distance-based ranges 402, identified as Range A 402A, Range B 402B, Range C 402C, and Range D 402D, although only two of the ranges are actively used in this configuration. Each range 402 includes a range interval 304, a corresponding attenuator switch state (ATT_SW) 306, an LNA bypass state (LNA_BYP) 308, an attenuation value 310, and an LNA operating mode 312. Further, one or more RSSI switch levels 314 (e.g., −11 dBm and −55 dBm) are used by the DGR device 112 to determine transitions between amplification and bypass states of the LNA 230 and between attenuation states of the attenuator 240.

In the illustrated example, Range A 402A corresponds to distances 304 greater than 300 meters. When the received signal is relatively weak at this distance, the DGR device 112 configures the attenuator 240 to apply no attenuation (e.g., 0 dB) while enabling the LNA 230 in a high-gain mode to amplify the signal. Ranges B 402B and C 402C are shown as unused in this example and are reserved for optional intermediate or alternative configurations. Range D 402D corresponds to distances 304 less than 300 meters. When the received signal is relatively strong due to close proximity to the signal emitter 120, the DGR device 112 configures the attenuator 240 to apply increased attenuation (e.g., −20 dB) while placing the LNA 230 in a bypass mode. In this two-range configuration, the DGR device 112 transitions directly between amplification and attenuation states based on inferred distance and signal characteristics, thereby reducing complexity while maintaining effective control of signal levels when tracking or processing signals having low EVM characteristics.

FIG. 4B is an example graph 450 illustrating the channel power 452 of the input signal at the DGR device 112 against an approximate range 454 (in meters (m)) in the two-range configuration of FIG. 4A. In this example, the “A” point illustrates the threshold RSSI value at which the DGR device 112 transitions from amplification (e.g., “Gain”) to no amplification (e.g., “Bypass”) and enables attenuation. More specifically, as the DGR device 112 is at an approximate distance of 300 meters or more from the signal emitter 120 (e.g., an unmodified RSSI value of <~−33 dBm), the DGR device 112 is amplifying the signal with +20 dB, thus resulting in a modified RSSI value of −11 dBm as shown at point “A”. When the DGR device 112 reaches the threshold value, the DGR device 112 changes the LNA 230 into “Bypass” mode, thus ceasing the amplification, and also activates the attenuator 240, thereby causing the input signal to be attenuated by −20 dB, as shown at point “D”. This attenuated mode continues through range 300 meters to 0 meters.

The gain ranging schemes illustrated in FIGS. 3A to 4B are merely exemplary, and aspects of the disclosure are operable with other gain ranging schemes.

FIG. 5A and FIG. 5B illustrate example spectral representation graphs 510, 520 demonstrating how the DGR device 112 uses dynamic gain ranging to selectively manage an effective noise floor to reduce the number of signals processed. FIG. 5A shows a power spectrum density distribution graph 510, in which the vertical axis 512 represents power spectrum density and the horizontal axis 514 represents frequency. In this example, a relatively low effective noise floor allows multiple signals to be visible above the noise floor, including a primary signal of interest and several other signals. FIG. 5B shows a power spectrum density distribution graph 520, in which the vertical axis 522 represents power spectrum density and the horizontal axis 524 represents frequency. In this example, the DGR device 112 has increased attenuation within the RF processing chain, thereby raising the effective noise floor and suppressing weaker or undesired signals below detectability while maintaining visibility of the primary signal. Together, FIGS. 5A and 5B illustrate how dynamic gain ranging may be used to control spectral visibility, simplify signal processing, and improve focus on a desired signal in environments containing multiple RF emitters.

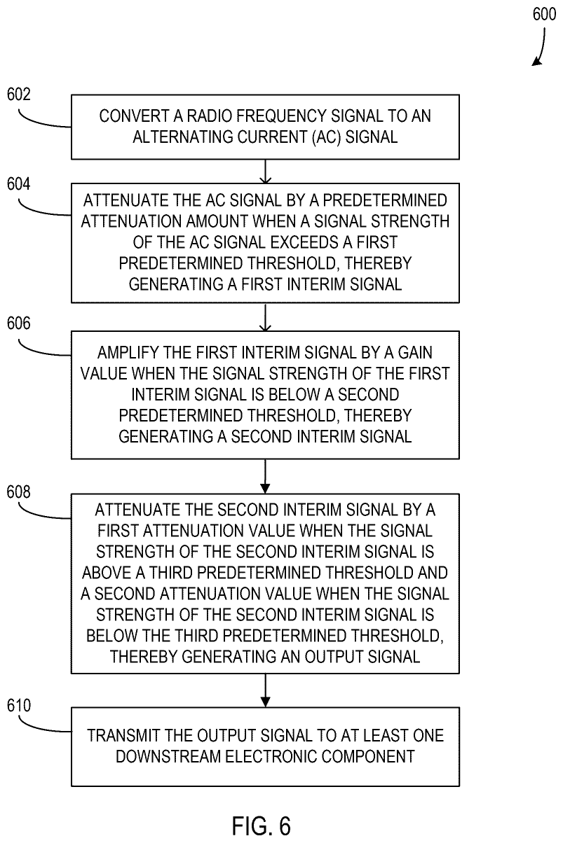

FIG. 6 is a flow chart illustrating example operations 600 performed by a dynamic gain ranging device, such as the DGR device 112 described herein. In the example, at operation 602, a radio frequency signal is received by an antenna of the DGR device 112 and converted into an alternating current (AC) signal. At operation 604, the DGR device 112 attenuates the AC signal by a predetermined attenuation amount when a signal strength of the AC signal exceeds a first predetermined threshold, thereby generating a first interim signal.

At operation 606, in the example, the DGR device 112 amplifies the first interim signal by a gain value when a signal strength of the first interim signal is below a second predetermined threshold, thereby generating a second interim signal. In some examples, amplifying the first interim signal includes selectively configuring a low-noise amplifier (LNA) between a high-gain mode and a bypass mode based on whether the signal strength of the first interim signal is below or above the second predetermined threshold.

At operation 608, in the example, the DGR device 112 attenuates the second interim signal by a first attenuation value when a signal strength of the second interim signal is above a third predetermined threshold and by a second attenuation value when the signal strength of the second interim signal is below the third predetermined threshold, thereby generating an output signal. In some examples, attenuating the second interim signal includes applying attenuation using a digitally controlled step attenuator configured to provide discrete attenuation increments over a predetermined attenuation range.

At operation 610, in the example, the DGR device 112 transmits the output signal to at least one downstream electronic component for further processing. In some examples, transmitting the output signal to the at least one downstream electronic component includes providing the output signal to an analog-to-digital converter and maintaining the output signal within an operational dynamic range of the analog-to-digital converter.

In some examples, the DGR device 112 determines the signal strength of one or more of the radio frequency signal, the first interim signal, and the second interim signal based on at least one of a received signal strength indicator (RSSI), channel power, or signal-to-noise ratio (SNR). In some examples, applying the first attenuation value and the second attenuation value is based on an inferred proximity between the antenna device and a signal emitter, such that increased attenuation is applied when the inferred proximity indicates closer distance to the signal emitter. In some examples, the DGR device 112 dynamically adjusts at least one of the first predetermined threshold, the second predetermined threshold, or the third predetermined threshold based on characteristics of the radio frequency signal.

The operations shown in FIG. 6 may be performed continuously or iteratively as signal conditions change, enabling dynamic adjustment of gain and attenuation to maintain signal integrity across varying signal strengths and operating environments.

In some examples, a method for processing signals in a dynamic gain ranging (DGR) device includes: providing a plurality of emitter signals to the DGR device; increasing a noise floor in the DGR device by introducing attenuation into a radio frequency (RF) processing chain; reducing a number of emitter signals that are processed by the DGR device by suppressing unwanted spurious signals and unwanted signals, through said increasing of the noise floor; and rendering the unwanted spurious and unwanted signals undetectable by the DGR device.

### Additional Examples

An example dynamic gain ranging device includes: an antenna configured to receive a radio frequency signal as an analog input signal; a circuit protection component including a first attenuator, the circuit protection component being configured to pass the analog input signal through the first attenuator when a signal strength of the analog input signal exceeds a first predetermined threshold, thereby generating a first interim signal; an amplification component configured to amplify the first interim signal by a gain value when the signal strength of the first interim signal is below a second predetermined threshold, thereby generating a second interim signal; and an attenuator component configured to: attenuate the second interim signal by a first attenuation value when the signal strength of the second interim signal is above a third predetermined threshold and a second attenuation value when the signal strength of the second interim signal is below the third predetermined threshold, thereby generating an output signal; and transmit the output signal to at least one downstream electronic component.

An example method of signal processing includes: converting, by an antenna device, a radio frequency signal to an alternating current (AC) signal; attenuating the AC signal by a predetermined attenuation amount when a signal strength of the AC signal exceeds a first predetermined threshold, thereby generating a first interim signal; amplifying the first interim signal by a gain value when the signal strength of the first interim signal is below a second predetermined threshold, thereby generating a second interim signal; attenuating the second interim signal by a first attenuation value when the signal strength of the second interim signal is above a third predetermined threshold and a second attenuation value when the signal strength of the second interim signal is below the third predetermined threshold, thereby generating an output signal; and transmitting the output signal to at least one downstream electronic component.

An example uncrewed aerial vehicle (UAV) includes: a flight control system configured to control navigation of the UAV; and a dynamic gain ranging device comprising: an antenna configured to receive a radio frequency signal as an analog input signal; a circuit protection component comprising a first attenuator, the circuit protection component being configured to pass the analog input signal through the first attenuator when a signal strength of the analog input signal exceeds a first predetermined threshold, thereby generating a first interim signal; an amplification component configured to amplify the first interim signal by a gain value when the signal strength of the first interim signal is below a second predetermined threshold, thereby generating a second interim signal; and an attenuator component configured to: attenuate the second interim signal by a first attenuation value when the signal strength of the second interim signal is above a third predetermined threshold and a second attenuation value when the signal strength of the second interim signal is below the third predetermined threshold, thereby generating an output signal; and transmit the output signal to the flight control system for navigation.

Alternatively, or in addition to the other examples described herein, examples include any combination of the following:
converting, by an antenna device, a radio frequency signal to an alternating current (AC) signal;
attenuating the AC signal by a predetermined attenuation amount when a signal strength of the AC signal exceeds a first predetermined threshold, thereby generating a first interim signal;
amplifying the first interim signal by a gain value when the signal strength of the first interim signal is below a second predetermined threshold, thereby generating a second interim signal;
attenuating the second interim signal by a first attenuation value when the signal strength of the second interim signal is above a third predetermined threshold and a second attenuation value when the signal strength of the second interim signal is below the third predetermined threshold, thereby generating an output signal;
transmitting the output signal to at least one downstream electronic component;
determining the signal strength of one or more of the radio frequency signal, the first interim signal, and the second interim signal based on at least one of a received signal strength indicator (RSSI), channel power, or signal-to-noise ratio (SNR);
selectively configuring a low-noise amplifier (LNA) between a high-gain mode and a bypass mode based on whether the signal strength of the first interim signal is below or above the second predetermined threshold;
applying attenuation using a digitally controlled step attenuator configured to provide discrete attenuation increments over a predetermined attenuation range;
applying the first attenuation value and the second attenuation value is based on an inferred proximity between the antenna device and a signal emitter, such that increased attenuation is applied when the inferred proximity indicates closer distance to the signal emitter;
dynamically adjusting at least one of the first predetermined threshold, the second predetermined threshold, or the third predetermined threshold based on characteristics of the radio frequency signal; and
providing the output signal to an analog-to-digital converter and maintaining the output signal within an operational dynamic range of the analog-to-digital converter.

While the aspects of the disclosure have been described in terms of various examples with their associated operations, a person skilled in the art would appreciate that a combination of operations from any number of different examples is also within scope of the aspects of the disclosure.

### Exemplary Operating Environment

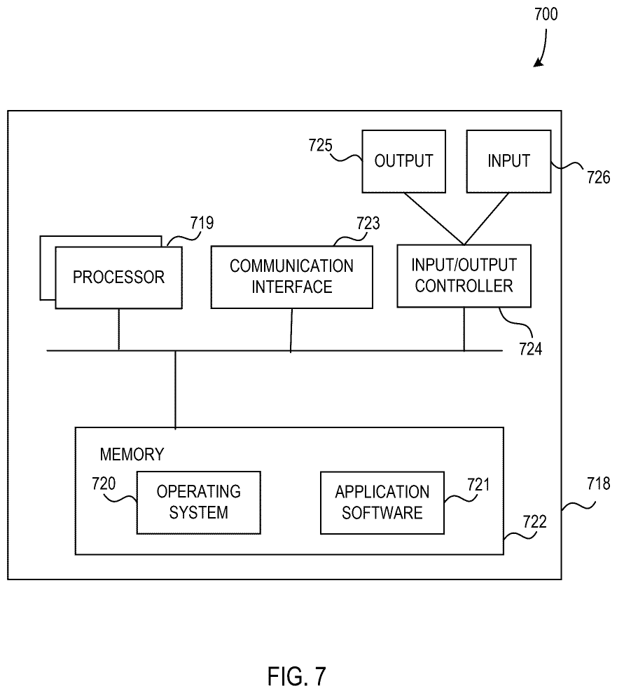

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device.

In some examples, computer executable instructions are provided using any computer-readable media that is accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display (e.g., displaying a GUI, etc.) or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receives output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps, etc.) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A dynamic gain ranging device comprising:
an antenna configured to receive a radio frequency signal as an analog input signal;
a circuit protection component including a first attenuator, the circuit protection component being configured to pass the analog input signal through the first attenuator when a signal strength of the analog input signal exceeds a first predetermined threshold, thereby generating a first interim signal;
an amplification component configured to amplify the first interim signal by a gain value when the signal strength of the first interim signal is below a second predetermined threshold, thereby generating a second interim signal; and
an attenuator component configured to:
attenuate the second interim signal by a first attenuation value when the signal strength of the second interim signal is above a third predetermined threshold and a second attenuation value when the signal strength of the second interim signal is below the third predetermined threshold, thereby generating an output signal; and
transmit the output signal to at least one downstream electronic component.

2. The dynamic gain ranging device of claim 1, wherein the signal strength of one or more of the analog input signal, the first interim signal, and the second interim signal is determined based on at least one of a received signal strength indicator (RSSI), a channel power, and signal-to-noise ratio (SNR).

3. The dynamic gain ranging device of claim 1, wherein the amplification component includes a low-noise amplifier (LNA) configurable between a high-gain mode and a bypass mode, and wherein the amplification component is placed in the high-gain mode when the signal strength of the first interim signal is below the second predetermined threshold and placed in the bypass mode when the signal strength exceeds the second predetermined threshold.

4. The dynamic gain ranging device of claim 1, wherein the attenuator component includes a digitally controlled step attenuator configured to apply attenuation in discrete increments over a predetermined attenuation range.

5. The dynamic gain ranging device of claim 1, wherein the first attenuation value is greater than the second attenuation value, such that the attenuator component applies increased attenuation when the signal strength of the second interim signal indicates closer proximity to a signal emitter.

6. The dynamic gain ranging device of claim 1, wherein at least one of the first predetermined threshold, the second predetermined threshold, and the third predetermined threshold corresponds to an inferred distance between the antenna and a signal emitter.

7. The dynamic gain ranging device of claim 1, wherein the attenuator component and the amplification component are dynamically controlled to maintain the output signal within an operational dynamic range of an analog-to-digital converter of the downstream electronic component.

8. A method of signal processing comprising:
converting, by an antenna device, a radio frequency signal to an alternating current (AC) signal;
attenuating the AC signal by a predetermined attenuation amount when a signal strength of the AC signal exceeds a first predetermined threshold, thereby generating a first interim signal;
amplifying the first interim signal by a gain value when the signal strength of the first interim signal is below a second predetermined threshold, thereby generating a second interim signal;
attenuating the second interim signal by a first attenuation value when the signal strength of the second interim signal is above a third predetermined threshold and a second attenuation value when the signal strength of the second interim signal is below the third predetermined threshold, thereby generating an output signal; and
transmitting the output signal to at least one downstream electronic component.

9. The method of claim 8, further comprising determining the signal strength of one or more of the radio frequency signal, the first interim signal, and the second interim signal based on at least one of a received signal strength indicator (RSSI), channel power, or signal-to-noise ratio (SNR).

10. The method of claim 8, wherein amplifying the first interim signal includes selectively configuring a low-noise amplifier (LNA) between a high-gain mode and a bypass mode based on whether the signal strength of the first interim signal is below or above the second predetermined threshold.

11. The method of claim 8, wherein attenuating the second interim signal includes applying attenuation using a digitally controlled step attenuator configured to provide discrete attenuation increments over a predetermined attenuation range.

12. The method of claim 8, wherein applying the first attenuation value and the second attenuation value is based on an inferred proximity between the antenna device and a signal emitter, such that increased attenuation is applied when the inferred proximity indicates closer distance to the signal emitter.

13. The method of claim 8, further comprising dynamically adjusting at least one of the first predetermined threshold, the second predetermined threshold, or the third predetermined threshold based on characteristics of the radio frequency signal.

14. The method of claim 8, wherein transmitting the output signal to the at least one downstream electronic component includes providing the output signal to an analog-to-digital converter and maintaining the output signal within an operational dynamic range of the analog-to-digital converter.

15. An uncrewed aerial vehicle (UAV) comprising:
a flight control system configured to control navigation of the UAV; and
a dynamic gain ranging device comprising:
an antenna configured to receive a radio frequency signal as an analog input signal;
a circuit protection component comprising a first attenuator, the circuit protection component being configured to pass the analog input signal through the first attenuator when a signal strength of the analog input signal exceeds a first predetermined threshold, thereby generating a first interim signal;
an amplification component configured to amplify the first interim signal by a gain value when the signal strength of the first interim signal is below a second predetermined threshold, thereby generating a second interim signal; and
an attenuator component configured to:
attenuate the second interim signal by a first attenuation value when the signal strength of the second interim signal is above a third predetermined threshold and a second attenuation value when the signal strength of the second interim signal is below the third predetermined threshold, thereby generating an output signal; and
transmit the output signal to the flight control system for navigation.

16. The uncrewed aerial vehicle of claim 15, wherein the dynamic gain ranging device is configured to determine the signal strength of one or more of the analog input signal, the first interim signal, and the second interim signal based on at least one of a received signal strength indicator (RSSI), channel power, or signal-to-noise ratio (SNR).

17. The uncrewed aerial vehicle of claim 15, wherein the amplification component comprises a low-noise amplifier (LNA) configurable between a high-gain mode and a bypass mode, and wherein the LNA is placed in the high-gain mode when the signal strength of the first interim signal is below the second predetermined threshold.

18. The uncrewed aerial vehicle of claim 15, wherein the attenuator component comprises a digitally controlled step attenuator configured to apply discrete attenuation increments over a predetermined attenuation range.

19. The uncrewed aerial vehicle of claim 15, wherein the dynamic gain ranging device is further configured to infer a distance between the UAV and a signal emitter based on characteristics of the received radio frequency signal, and to adjust at least one of the first attenuation value or the second attenuation value based on the inferred distance.

20. The uncrewed aerial vehicle of claim 15, wherein the flight control system is configured to navigate the UAV toward or away from a signal emitter based at least in part on the output signal provided by the dynamic gain ranging device.
